(19) United States
(12) Patent Application Publication
(10) Pub. No.: US 2005/0213075 A1
(43) Pub. Date: Sep. 29, 2005

(54) Target identification system and method

(76) Inventor: Bradly J. Cooke, Jemez Springs, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 11/034,037

(22) Filed: Jan. 12, 2005

Related U.S. Application Data
(63) Continuation of application No. 10/016,848, filed on Dec. 14, 2001.

(51) Int. Cl. G01C 3/08; G01P 3/36

(52) U.S. Cl. 356/28; 356/28.5; 356/4.01; 356/5.01; 356/4.06; 356/5.11

(57) ABSTRACT

A system and method for target identification are disclosed. In one embodiment, a light source emits a beam of electromagnetic radiation with a wavelength that is shorter than one millimeter. The beam is split by a beam splitter into a first portion and a second portion. The first portion is modulated by a first modulating device to form a first modulated portion. The second portion is modulated by a second modulating device to form a second modulated portion. The first and second modulating devices may each take the form of a single modulator. Alternately, the first and second modulating devices may each take the form of a plurality of modulators. The first and second modulated portions are combined by a beam combiner to form a hybrid beam. The hybrid beam is directed to an aperture, where it is radiated toward a reflective target. A reflected portion of the beam is reflected off the reflective target in the direction of the aperture. The reflected portion and background noise are collected by the aperture and directed to a receiver. The receiver determines information about the target by processing the received signal, which includes a difference signal, i.e., a signal representing the difference between the first modulated portion and the second modulated portion. Because fluctuations and distortions due to source, atmosphere, and target are identically superimposed upon the first modulated portion and second modulated portion, these fluctuations and distortions will not appear in the difference signal. Thus, a high detection efficiency may be achieved.

### GOVERNMENT RIGHTS

This invention was made with Government support under Contract Number W 7405-ENG-36 awarded by the United States Department of Energy to The Regents of the University of California. The Government has certain rights in the invention.

### BACKGROUND OF THE INVENTION

1. Field of the Invention

The present invention relates to a system and method for acquiring information about a target. More specifically, the invention relates to radiating a reflective target with an emission of electromagnetic radiation that has been created from two differently modulated emissions in order to achieve a high efficiency.

2. Description of Related Art

Target identification can be defined as the acquisition of information about a target. As used herein, “information” refers to any desired characteristic of a target, such as a target's range, velocity, trajectory, surface roughness, or the like. Acquiring information may involve generating an image of a target.

Target identification is becoming vitally important both for military and civilian objectives. In the military sector, the ability to acquire information about a target through background noise such as fog, smoke, and foliage while mitigating the detrimental effects of turbulence is vitally important. In the industrial or commercial sector, acquiring information about targets such as precision parts, electronic components, and optical components for quality control and other purposes is of rapidly growing importance.

In the past, electronic systems have been used for target identification. However, optical systems have several advantages over these conventional electronic systems. Among these advantages are increased speed of producing an image, enhanced dynamic range, improved resolution, and a higher degree of reliability.

Known optical target identification systems, however, suffer from a lack of efficiency. For example, referring to FIG. 1, there is shown a block diagram of a known optical target identification system 100. A source 110 emits an emission 112 of electromagnetic radiation. The source 110 may be any source of electromagnetic radiation, such as a light source. The emission 112 may take the form of a light beam 112. The beam 112 typically has a wavelength shorter than one millimeter.

The beam 112 is directed to an aperture 176, where it is radiated toward a reflective target 180. As used herein, a “reflective target” is any target, either moving or stationary, that reflects electromagnetic radiation. A reflected portion 186 of the beam 112 is reflected off the reflective target 180 in the direction of the aperture 176. The reflected portion 186 and background noise 192 are collected by the aperture 176 and directed to a receiver 198.

The receiver 198 determines information about the target 180 by processing the received signal, which consists of both the reflected portion 186 and the background noise 192. The receiver 198 in FIG. 1 is configured for direct detection. In particular, the receiver 198 includes a detector (not shown). Incident photons of light directly stimulate an electrical signal in the detector whose amplitude is proportional to the optical power of the incident photons. Information about the target 180 is determined by processing the electrical signal with the appropriate processing circuitry.

An optical receiver's overall detection efficiency is quantified by both the receiver's quantum efficiency and its ability to discriminate between signal (e.g., desired information) and unwanted background clutter. One disadvantage of the system 100 shown in FIG. 1 is its low detection efficiency as a result of poor signal-to-background clutter rejection. The signal-to-background clutter rejection portion of the detection efficiency is a measure of how much of the signal processed by the receiver 198 consists of the reflected portion 186 as opposed to the background noise 192. It is desirable to maximize the detection efficiency. However, the receiver 198 in FIG. 1 cannot effectively separate the reflected portion 186 from the background noise 192. Hence, the receiver 198 possesses a low detection efficiency.

Referring now to FIG. 2, there is shown another known optical target identification system 200. The target identification system 200 shown in FIG. 2 is configured for coherent detection. In particular, a coherent source 210 emits an emission 212 of electromagnetic radiation. The coherent source 210 may be any source of coherent electromagnetic radiation, such as a laser. The emission 212 may take the form of a laser beam 212. The beam 212 typically has a wavelength shorter than one millimeter.

The beam 212 is directed to an aperture 276, where it is radiated toward a reflective target 280. A reflected portion 286 of the beam 212 is reflected off the reflective target 280 in the direction of the aperture 276. The reflected portion 286 and background noise 292 are collected by the aperture 276. A local oscillator 294 generates a local oscillator beam 295, which is coherent with the beam 212 and, ideally, with the reflected portion 286. A mixer 296 multiplies the reflected portion 286 and the background noise 292 with the local oscillator beam 295, generating an intermediate frequency signal 297. Typically, the intermediate frequency signal 297 has a frequency between that of the reflected portion 286 and the local oscillator beam 295.

The receiver 298 determines information about the target 280 by processing the intermediate frequency signal 297. As with the receiver 198 in FIG. 1, the receiver 298 includes a detector (not shown). Incident photons of light directly stimulate an electrical signal in the detector whose amplitude is proportional to the optical power of the incident photons. Information about the target 280 is determined by processing the electrica signal with the appropriate processing circuitry.

Ideally, the target identification system 200 shown in FIG. 2 has a higher detection efficiency than the target identification system 100 shown in FIG. 1. This is because the local oscillator beam 295 is, at least in theory, coherent with the reflected portion 286. In particular, when the intermediate frequency signal 297 stimulates an electrical signal in the detector, the amplitude of the electrical signal corresponding to the reflected portion 286 should be proportional to the electric field of the reflected portion 286 multiplied by the electric field of the local oscillator beam 295, which can be made sufficiently intense to overwhelm the background noise 292.

In practice, however, the detection efficiency of the target identification system 200 shown in FIG. 2 falls well short of its theoretical value. This is because the reflected portion 286 generally has “phase speckle,” which is a random assortment of nonuniform phase fronts. Phase speckle can be caused by a variety of factors. For example, the target 280 may have an optically rough surface, the beam 212 and' the reflected portion 286 may be propagated through a turbulent atmosphere, and/or the beam 212 and the reflected portion 286 may be distorted by imperfections within the optical system 200. Whatever the cause, illuminating the receiver 298 with a coherent local oscillator beam 295 and a speckled reflected portion 286 results in a poor overall detection efficiency.

There are two other disadvantages associated with the target identification system 200 shown in FIG. 2. First, the source 210 must be coherent. Second, mismatches between the local oscillator beam 295 and the reflected portion 286 require that the receiver 298 has a large bandwidth, in the range of 100-1000 MHz. Where imaging of the target 280 is desired, the large bandwidth requirement prohibits the use of currently available focal plane array or CCD imaging technology.

Accordingly, a need exists for a target identification system that has a high detection efficiency, that supports coherent or incoherent sources, and that allows the use of currently available focal plane array or CCD imaging technology.

### SUMMARY OF THE INVENTION

The system and method of the present invention have been developed in response to the present state of the art, and in particular, in response to the problems and needs in the art that have not yet been fully solved by currently available target identification systems. In accordance with the invention embodied and broadly described herein, a novel system and method for acquiring information about a target are disclosed.

In one embodiment, a source emits an emission of electromagnetic radiation. The source may be any source of electromagnetic radiation, such as a light source. Advantageously, the source may be either coherent or incoherent. The emission may take the form of a light beam. Typically, the light beam has a wavelength shorter than one millimeter.

The beam is split by a beam splitter into a first portion and a second portion. The first portion is modulated by a first modulating device to form a first modulated portion. The second portion is modulated by a second modulating device to form a second modulated portion. The first and second modulating devices may each take the form of a single modulator. Alternately, the first and second modulating devices may each take the form of a plurality of modulators.

As used herein, to “modulate” an emission of electromagnetic radiation means to alter one of its detectable characteristics, such as its amplitude, frequency, phase, polarization, or the like. A variety of modulators may be used to implement the first and second modulators, including but not limited to electro-optic, opto-mechanical, acoustooptic, photorefractive, ferroelectric, and magneto-optic modulators.

The first and second modulated portions are combined by a beam combiner to form a hybrid beam. The hybrid beam is directed to an aperture, where it is radiated toward a reflective target. A reflected portion of the beam is reflected off the reflective target in the direction of the aperture. The reflected portion and background noise are collected by the aperture and directed to a receiver.

The receiver determines information about the target by processing the received signal, which consists of both the reflected portion and the background noise. In particular, the receiver includes a detector. Incident photons of light directly stimulate an electrical signal in the detector whose amplitude is proportional to the optical power of the incident photons. Information about the target is determined by processing the. electrical signal with the appropriate processing circuitry.

A target identification system in accordance with the invention is able to overcome the problems associated with known target identification systems, including the problems associated phase speckle described above. This is because the receiver detects a difference signal corresponding to the difference between the first modulated portion and the second modulated portion. Because fluctuations and distortions due to source, atmosphere, and target are identically superimposed upon the first modulated portion and second modulated portion, these fluctuations and distortions will cancel out upon detection. Thus, a target identification system in accordance with the invention has a high detection efficiency.

Advantageously, a target identification system in accordance with the invention may utilize a receiver that is configured for direct detection. Therefore, the receiver need not have a large bandwidth. However, a receiver configured for coherent detection may be used in accordance with the present invention.

Another significant advantage of the invention is that the hybrid beam propagates coherently, regardless of whether the source is coherent. Therefore, the source may be either coherent or incoherent. Alternately, the source may be coherent, and a phase destroying device may be utilized to destroy the coherence of the second portion so that the first portion is coherent and the second portion is incoherent.

The fact that the hybrid beam propagates coherently allows the reflected portion to be effectively separated from the background noise. This is because the difference between the first modulated portion and the second modulated portion remains substantially the same during propagation. Therefore, the desired difference signal is known at the receiver, and appropriate filters may be used to eliminate the background noise.

In one alternate embodiment, the beam emitted by the source is split into more than two portions. Each portion is differently modulated and recombined to form a hybrid beam. In another alternate embodiment, a plurality of sources are utilized and assigned a different bandwidth. Such an embodiment enables information to be determined about multiple targets that, for example, reflect different frequencies of electromagnetic radiation.

These and other features and advantages of the present invention will become more fully apparent from the following description and appended claims, or may be learned by the practice of the invention as set forth hereinafter.

### BRIEF DESCRIPTION OF THE DRAWINGS

In order that the manner in which the above-recited and other advantages of the invention will be readily understood, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is a block diagram of a known optical target identification system;

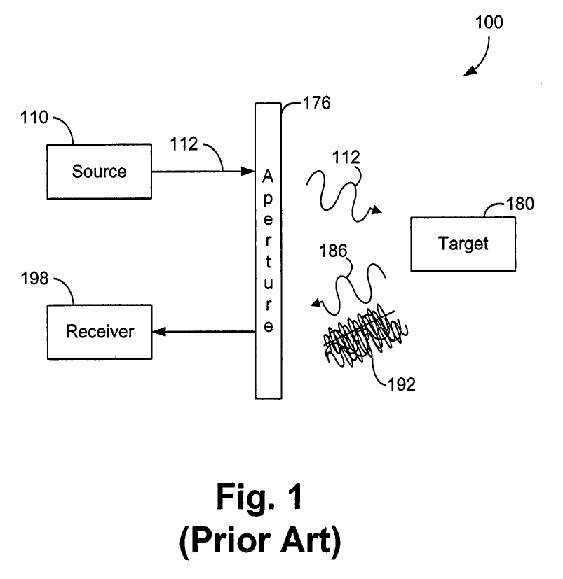

FIG. 2 is a block diagram of a known optical target identification system;

FIG. 3 is a block diagram of a target identification system in accordance with the invention;

FIG. 4 is a flowchart illustrating a method for acquiring information about a target in accordance with the invention;

FIG. 5 is a block diagram of a receiver in accordance with the invention;

FIG. 6 is a block diagram of an alternate target identification system in accordance with the invention;

FIG. 7 is a block diagram of an alternate target identification system in accordance with the invention;

FIG. 8 is a block diagram of an alternate target identification system in accordance with the invention; and

FIG. 9 is a graph showing the spectral reflectivity of targets used in an experiment in accordance with the invention.

### DETAILED DESCRIPTION OF THE PREFERRED EMBODIMENTS

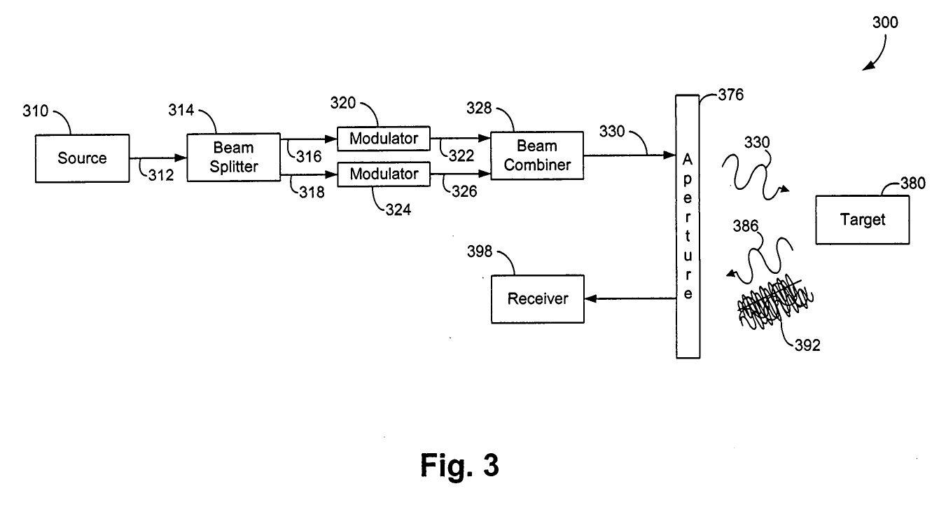

The presently preferred embodiments of the present invention will be best understood by reference to the drawings, wherein like parts are designated by like numerals throughout. It will be readily understood that the components of the present invention, as generally described and illustrated in the figures herein, could be arranged and designed in a wide variety of different configurations. Thus, the following more detailed description of the embodiments of the system and method of the present invention, as represented in FIGS. 3 through 8, is not intended to limit the scope of the invention as claimed, but is merely representative of presently preferred embodiments of the invention.

Referring to FIG. 3, there is shown a block diagram of a target identification system 300 in accordance with the present invention. A source 310 emits an emission 312 of electromagnetic radiation. The source 310 maybe any source of electromagnetic radiation, such as a light source, and may be either continuous wave or pulsed. Advantageously, the source 310 may be either coherent (e.g., a laser beam) or incoherent (e.g., an incandescent lamp). The emission 312 may take the form of a light beam 312. The beam 312 typically has a wavelength shorter than one millimeter.

The beam 312 is split by a beam splitter 314 into a first portion 316 and a second portion 318. The first portion 316 is modulated by a first modulating device 320 to form a first modulated portion 322. The second portion 318 is modulated by a second modulating device 324 to form a second modulated portion 326. In FIG. 3, the first modulating device 320 takes the form of a first modulator 320, and the second modulating device 324 takes the form of a second modulator 324.

As used herein, to “modulate” an emission of electromagnetic radiation means to alter one of its detectable characteristics, such as its amplitude, frequency, phase, polarization, or the like. A variety of modulators may be used to implement the first modulator 320 and second modulator 324, including but not limited to electro-optic, opto-mechanical, acousto-optic, photorefractive, ferroelectric, and magneto-optic modulators.

The first modulated portion 322 and second modulated portion 324 are combined by a beam combiner 328 to form a hybrid beam 330. The hybrid beam 330 is directed to an aperture 376, where it is radiated toward a reflective target 380. As described above, a reflective target 380 is any target that reflects electromagnetic radiation, and may be either moving or stationary. A reflected portion 386 of the beam 312 is reflected off the reflective target 380 in the direction of the aperture 376. The reflected portion 386 and background noise 392 are collected by the aperture 376 and directed to a receiver 398.

The receiver 398 determines information about the target 380 by processing the received signal, which consists of both the reflected portion 386 and the background noise 392. In particular, the receiver 398 includes a detector (not shown). Incident photons of light directly stimulate an electrical signal in the detector whose amplitude is proportional to the optical power of the incident photons. Information about the target 380 is determined by processing the electrical signal with the -appropriate processing circuitry. Although in FIG. 3 the source 310 and the receiver 398 are co-located (i.e., located in the same area), the source 310 and the receiver 398 may be located in different areas in accordance with the invention.

The target identification system 300 in FIG. 3 has a high detection efficiency because it is able to overcome the problems described above that are associated with phase speckle. In particular, the reflected portion 386 consists of a first modulated portion 322 and a second modulated portion 326. The first modulated portion 322 and the second modulated portion 326 are differently modulated. Thus, upon detection by the receiver 398, a difference signal will be produced corresponding to a difference between the first modulated portion 322 and the second modulated portion 326. Because fluctuations and distortions due to source, atmosphere, and target are identically superimposed upon the first modulated portion 322 and second modulated portion 326, these fluctuations and distortions will cancel out upon detection.

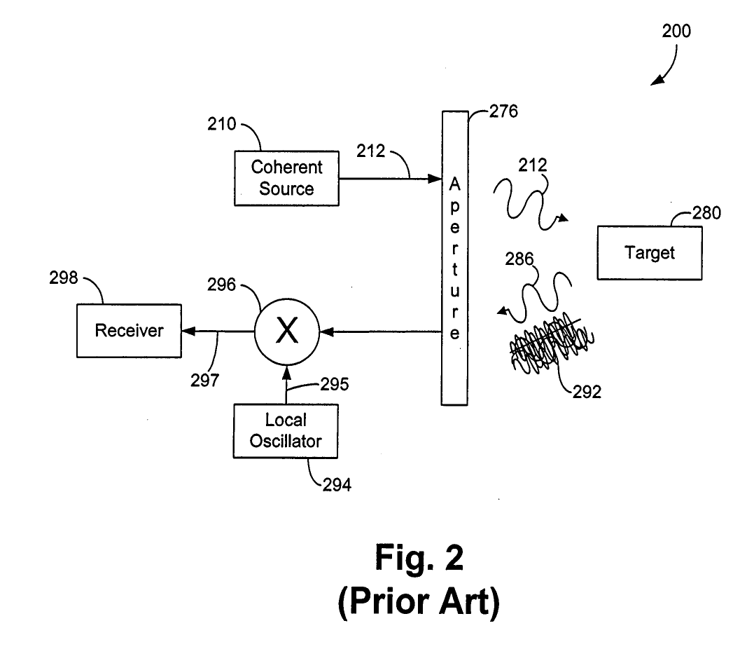

Advantageously, the receiver 398 may be configured for direct detection, as shown in FIG. 3. Therefore, the receiver 398 need not have a large bandwidth. Moreover, the use of a direct detection receiver 398 eliminates potential noise from the additional components required for a coherent detection system, such as a local oscillator and mixer. However, a receiver configured for coherent detection, similar to that shown in FIG. 2, may be used in accordance with the invention.

Another significant advantage of the system 300 is that the hybrid beam 330 propagates coherently, regardless of whether the source 310 is coherent. Therefore, the source 310 may be either coherent or incoherent. Alternately, the source may be coherent, and a phase destroying device may be utilized to destroy the coherence of the second portion so that the first portion is coherent and the second portion is incoherent.

In addition, the fact that the hybrid beam 330 propagates coherently allows the reflected portion 386 to be effectively separated from the background noise 392. This is because the difference between the first modulated portion 322 and the second modulated portion 326 remains substantially the same during propagation. Therefore, the desired difference signal is known at the receiver 398, and appropriate filters may be used to eliminate the background noise 392.

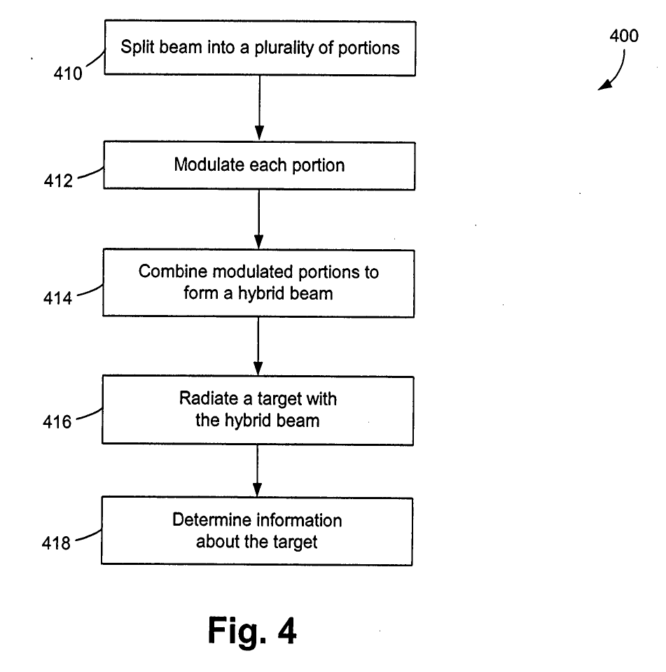

Referring now to FIG. 4, there is shown a flowchart illustrating a method 400 for acquiring information about a target. The method 400 begins by splitting 410 an emission of electromagnetic radiation, such as a beam of light, into a plurality of portions. Each portion of the beam is modulated 412 with a modulating device, forming a plurality of modulated portions. Thereafter, the modulated portions are combined 416 to form a hybrid beam. A reflective target is radiated 418 with the hybrid beam to form a reflected portion. The reflected portion consists of the modulated portions. Information is then determined 420 about the target by processing the reflected portion. For example, a difference between the modulated portions may be detected and processed to provide desired information about the target.

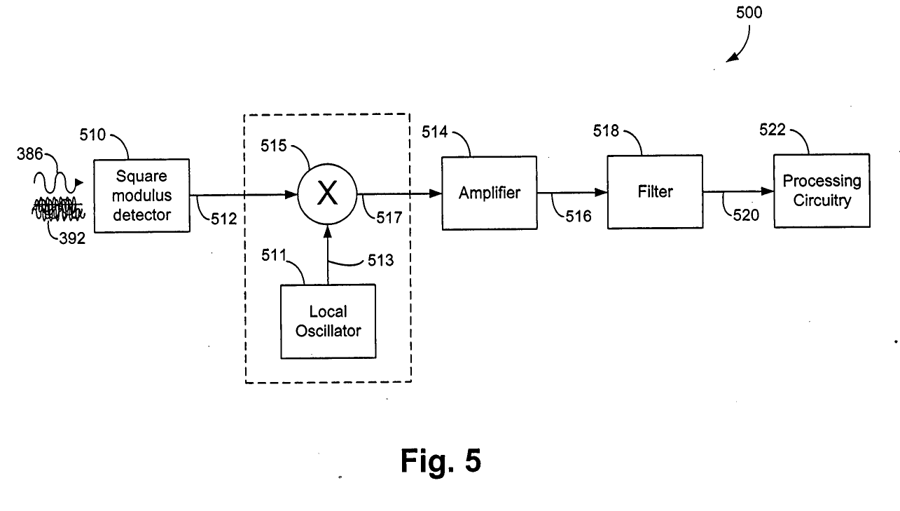

Referring now to FIG. 5, there is shown a block diagram of a receiver 500 in accordance with the invention. The reflected portion 386 and background noise 392 are incident upon a detector 510. The detector 510 shown in FIG. 5 is a square modulus detector, and a variety of detectors 510 may be used in accordance with the invention, including photodiodes, photoconductors, bolometers, pyroelectric, photocathodes, and the like.

As described above, the detector 510 converts the incident photons within the reflected portion 386 and background noise 392 into an electrical signal, creating a detected signal 512. The detected signal consists of an electrical signal having two components: first, the difference between the first modulated portion 322 and the second modulated portion 326, and second, the background noise 392.

The receiver 500 shown in FIG. 5 may optionally include a local oscillator 511 and a mixer 513. The local oscillator 511 generates a down-converting signal 513. A mixer 515 multiplies the detected signal 512 with the down-converting signal 513, generating an intermediate frequency signal 517. The principle function of the local oscillator 511 and mixer 513 is the down-conversion of optional high frequency signals, employed in range and Doppler imaging, to low intermediate frequency formats commensurate, for example, with CCD or photodiode imaging arrays. A variety of local oscillator 511 formats may be employed including sinusoid, chirped FM, and pulsed waveforms. Applicable mixer 513 technologies include gated photocathode tubes, multichannel plate (MCP) multipliers, blocked impurity band (BIB) devices, and avalanche photodiodes.

An amplifier 514 may be used to amplify the intermediate frequency signal 517. The amplifier 514 may take the form of a multi-channel plate (MCP) electron multiplier. A filter 518 may be used to filter out the background noise 392 from the detected signal 512, creating a filtered signal 520. The filter 518 may take the form of a bandpass filter tuned to pass signals having a frequency corresponding to the difference between the first modulated portion 322 and the second modulated portion 326.

The filtered signal 520 is then delivered to the appropriate processing circuitry 522. The processing circuitry 522 determines information about the target 380. For example, if the desired information involves generating an image of the target 380, then the processing circuitry may take the form of a CCD imaging array. If the desired information involves calculating a range of the target 380 (i.e., the distance between the aperture 376 and the target 380), then a pulsed source 310 may be used, and the processing circuitry 522 may consist of a timing circuit configured to count the periods of a suitable clock signal. If information about the velocity of a moving target is desired, the receiver 500 may include a local oscillator and a mixer to downconvert a Dopplershifted reflected portion to an intermediate frequency. Of course, the processing circuitry 522 may take numerous forms depending on the type of information desired.

FIG. 5 illustrates only one possible configuration of a receiver 500. As stated above, a receiver configured for coherent detection may also be used in accordance with the invention. In addition, those skilled in the art will recognize that various other configurations may be used within the scope of the invention. Also, various standard components are not illustrated in FIG. 5 in order to avoid obscuring aspects of the invention.

The embodiment of the invention shown generally in FIGS. 3-5 was experimentally tested and shown to achieve a high detection efficiency. In one experiment, the source 310 was a class IIIA HeNe laser. The first modulator 320 and second modulator 324 were two LiNbO3 electro-optic phase modulators. The target 380 a piece of paper with a printing on it to provide an optically rough surface. The target 380 was located 7.8 meters away from the source 310 and 4.4 meters away from the receiver 398. The desired information took the form of an image of the target 380; thus, the processing circuitry 522 consisted of an 8-bit digital CCD camera in tandem with a commercial frame grabber for image capture, and a Windows NT computer to process the raw CCD frames and display the retrieved images. An incandescent lamp provided the background noise 392. During the experiment, the printing on the piece of paper was clearly delineated from the background noise in a retrieved image, with a detection efficiency approaching 100%.

In another experiment, a flower was used for the target 380. The power of the class IIIA HeNe laser used for the source 310 was reduced to 4 nW/cm2. At this level, the laser light reflected from the target was below the sensitivity of the human eye. Still, the flower was clearly delineated from the background noise in the retrieved image, with a detection efficiency approaching 100%.

In yet another experiment, the source 310 consisted of an incandescent lamp, a UV filter, and an optical collimator. The UV filter was required to prevent photo-electric damage to the LiNbO3 electro-optic phase modulators, and the collimator enabled the light to be focused through the modulators. The source 310 was aimed in the direction of a white piece of paper adhered to the wall. An MTF mask projecting the number “2” was placed in between the source 310 and the target 380. Thus, the target 380 was the white number “2,” and the background noise 392 was the white piece of paper. The white number “2” was clearly delineated from the indistinguishable background in the retrieved image, with a detection efficiency of approximately 90%.

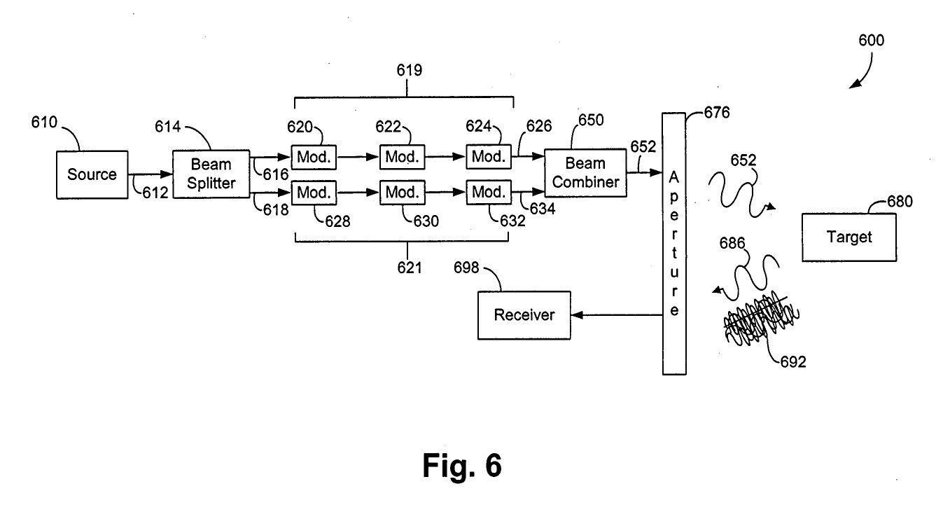

Referring now to FIG. 6, there is shown a block diagram of an alternate target identification system 600 in accordance with the present invention. A source 610 emits an emission 612 of electromagnetic radiation. The source 610 may be any source of electromagnetic radiation, may be either coherent or incoherent, and may be either continuous wave or pulsed. The emission 612 may take the form of a light beam 612. The beam 612 typically has a wavelength shorter than one millimeter.

The beam 612 is split by a beam splitter 614 into a first portion 616 and a second portion 618. The first portion 616 is modulated by a first modulating device 619 to form a first modulated portion 626. The second portion 618 is modulated by a second modulating device 621 to form a second modulated portion 634. In FIG. 6, the first modulating device 619 and the second modulating device 621 each take the form of a plurality of modulators. In particular, the first modulating device 619 takes the form of a first modulator 620, a second modulator 622, and a third modulator 624. The second modulating device 621 takes the form of a first modulator 628, a second modulator 630, and a third modulator 632.

The first modulating device 619 and second modulating device 621 may take the form of a multi-element spatial modulator. A variety of modulators may be used to implement the modulators 620, 622, 624, 628, 630, and 632, including but not limited to electro-optic, opto-mechanical, acousto-optic, photorefractive, ferroelectric, and magneto-optic modulators. Although in FIG. 6 the first modulating device 619 and second modulating device 621 each have three modulators, as many modulators as desired may be used in accordance with the invention.

The first modulated portion 626 and second modulated portion 634 are combined by a beam combiner 650 to form a hybrid beam 652. The hybrid beam 652 is directed to an aperture 676, where it is radiated toward a reflective target 680. A reflected portion 686 of the beam 612 is reflected off the reflective target 680 in the direction of the aperture 676. The reflected portion 686 and background noise 692 are collected by the aperture 676 and directed to a receiver 698. The receiver 698 determines information about the target 680 by processing the received signal, which consists of both the reflected portion 686 and the background noise 692, in a manner similar to that described above.

The embodiment of the invention shown generally in FIG. 6 was experimentally tested and shown to achieve a high detection efficiency. Again, the source 610 was a class IIIA HeNe laser. The first modulating device 619 and second modulating device 621 took the form of a 69-element spatial modulator. The target 680 was a piece of paper with printing on it to provide an optically rough surface. The target 680 was located 7.8 meters away from the source 610 and 4.4 meters away from the receiver 698. The desired information was an image of the target 380; thus, the processing circuitry 522 consisted of an 8-bit digital CCD camera in tandem with a commercial frame grabber for image capture, and a Windows NT computer to process the raw CCD frames and display the retrieved images. An incandescent lamp provided the background noise 692. Several folds of plastic wrap were placed between the beam combiner 650 and the target 680 in order to simulate an optically rough transmission medium. Once again, the printing on the piece of paper was clearly delineated from the background noise in the retrieved image, with a detection efficiency approaching 100%.

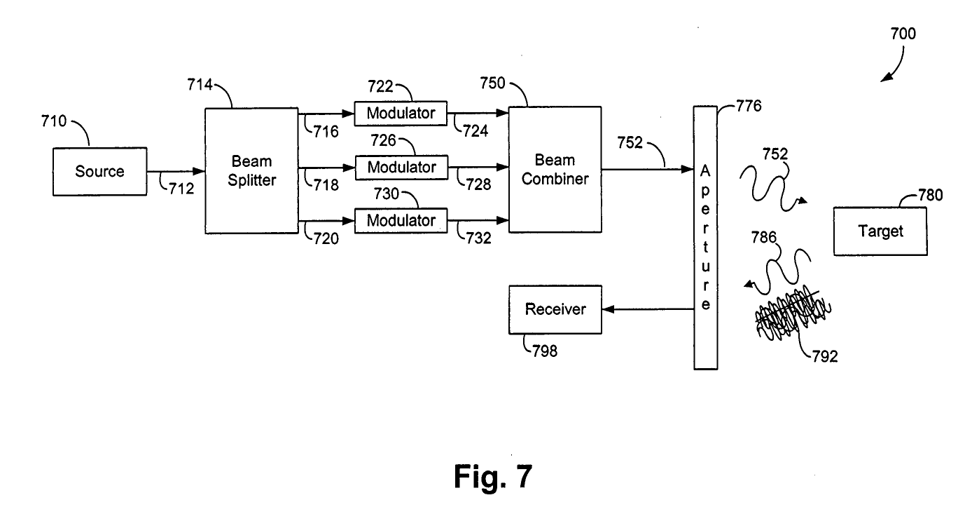

Referring now to FIG. 7, there is shown a block diagram of an alternate target identification system 700 in accordance with the present invention. A source 710 emits an emission 712 of electromagnetic radiation. The source 710 maybe any source of electromagnetic radiation, may be either coherent or incoherent, and may be either continuous wave or pulsed. The emission 712 may take the form of a light beam 712. The beam 712 typically has a wavelength shorter than one millimeter.

The beam 712 is split by a beam splitter 714 into a first portion 716, a second portion 718, and a third portion 720. Although in FIG. 7 the beam 712 is split into three portions, the beam 712 may be split into as many portions as desired. The first portion 714 is modulated by a first modulating device 722 to form a first modulated portion 724. The second portion 718 is modulated by a second modulating device 726 to form a second modulated portion 728. The third portion 720 is modulated by a third modulating device 730 to form a third modulated portion 732. In FIG. 7, the first modulating device 722 takes the form of a first modulator 722, the second modulating device 726 takes the form of a second modulator 726, and the third modulating device 730 takes the form of a third modulator 730.

The first modulated portion 724, second modulated portion 728, and third modulated portion 732 are combined by a beam combiner 750 to form a hybrid beam 752. The hybrid beam 752 is directed to an aperture 776, where it is radiated toward a reflective target 780. A reflected portion 786 of the beam 752 is reflected off the reflective target 780 in the direction of the aperture 776. The reflected portion 786 and background noise 792 are collected by the aperture 776 and directed to a receiver 798. The receiver 798 determines information about the target 780 by processing the received signal, which consists of both the reflected portion 786 and the background noise 792, in a manner similar to that described above.

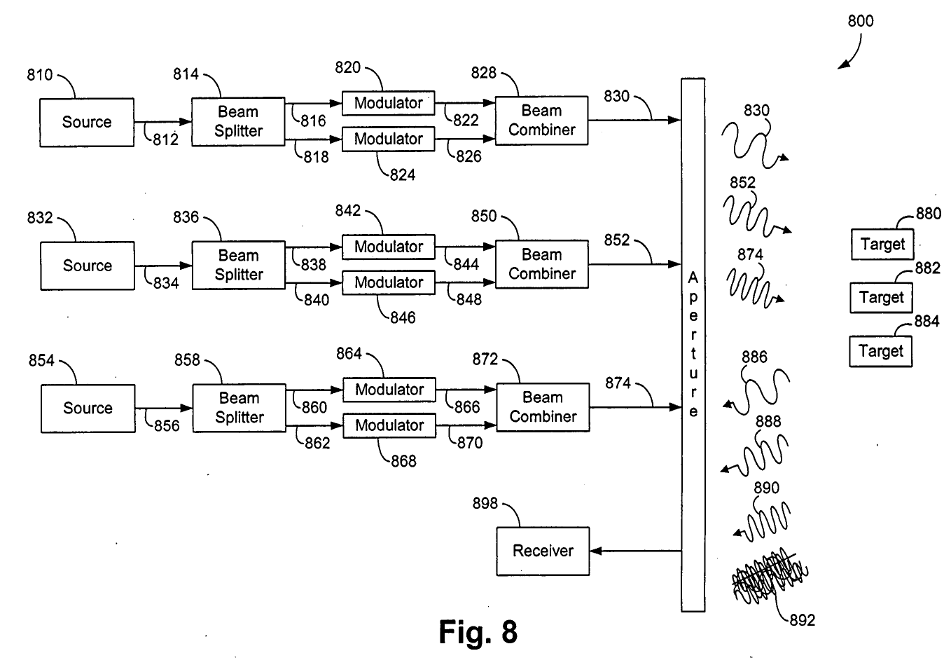

Referring now to FIG. 8, there is shown a block diagram of an alternate target identification system 800 in accordance with the present invention. A first source 810 emits a first emission 812 of electromagnetic radiation. A second source 832 emits a second emission 834 of electromagnetic radiation. A third source 854 emits a third emission 856 of electromagnetic radiation. The first source 810, second source 832, and third source 854 may be any source of electromagnetic radiation, may be either coherent or incoherent, and may be either continuous wave or pulsed. The first emission 812, second emission 834, and third emission 856 may take the form of first, second, and third light beams 812, 834, and 856. The first, second, and third beams 812, 834, and 856 typically have a wavelength shorter than one millimeter.

The first beam 812 is split by a first beam splitter 814 into a first portion 816 and a second portion 818. The first portion 816 is modulated by a first modulating device 820 to form a first modulated portion 822. The second portion 818 is modulated by a second modulating device 824 to form a second modulated portion 826. The first modulating device 820 takes the form of a first modulator 820, and the second modulating device 820 takes the form of a second modulator 824. The first modulated portion 822 and second modulated portion 826 are combined by a first beam combiner 828 to form a first hybrid beam 830.

The second beam 832 is split by a second beam splitter 836 into a first portion 838 and a second portion 840. The first portion 838 is modulated by a third modulating device 842 to form a third modulated portion 844. The second portion 840 is modulated by a fourth modulating device 846 to form a fourth modulated portion 848. The third modulating device 842 takes the form of a third modulator 842, and the fourth modulating device 846 takes the form of a fourth modulator 846. The third modulated portion 844 and fourth modulated portion 848 are combined by a second beam combiner 850 to form a second hybrid beam 852.

The third beam 856 is split by a third beam splitter 858 into a first portion 860 and a second portion 862. The first portion 860 is modulated by a fifth modulating device 864 to form a fifth modulated portion 866. The second portion 862 is modulated by a sixth modulating device 868 to form a sixth modulated portion 870. The fifth modulating device 864 takes the form of a fifth modulator 864, and the sixth modulating device 868 takes the form of a sixth modulator 870. The fifth modulated portion 866 and sixth modulated portion 870 are combined by a third beam combiner 872 to form a third hybrid beam 874.

The first hybrid beam 830, second hybrid beam 852, and third hybrid beam 874 are directed to an aperture 876. The first hybrid beam 830 is radiated toward a first reflective target 880, the second hybrid beam 852 is radiated toward a second reflective target 882, and the third hybrid beam 874 is radiated toward a third reflective target 884. Although three sources and targets are shown in FIG. 8, as many as desired may be used.

A first reflected portion 886 of the first hybrid beam 830 is reflected off the first reflective target 880 in the direction of the aperture 876, a second reflected portion 888 of the second hybrid beam 852 is reflected off the second reflective target 882 in the direction of the aperture 876, and a third reflected portion 890 of the third hybrid beam 874 is reflected off the third reflective target 884 in the direction of the aperture 876. The first reflected portion 886, second reflected portion 888, third reflected portion 890, and background noise 892 are collected by the aperture 876 and directed to a receiver 898. The receiver 898 determines information about the first target 880, second target 882, and third target 884 by processing the received signal in a manner similar to that described above.

The first source 810, second source 832, and third source 854 may be assigned distinct bandwidths. This enables information to be determined about multiple targets that, for example, reflect different frequencies of electromagnetic radiation. Such an embodiment has a wide variety of applications, including in laser spectroscopy, active polarimetry, phase interferometry, and the like.

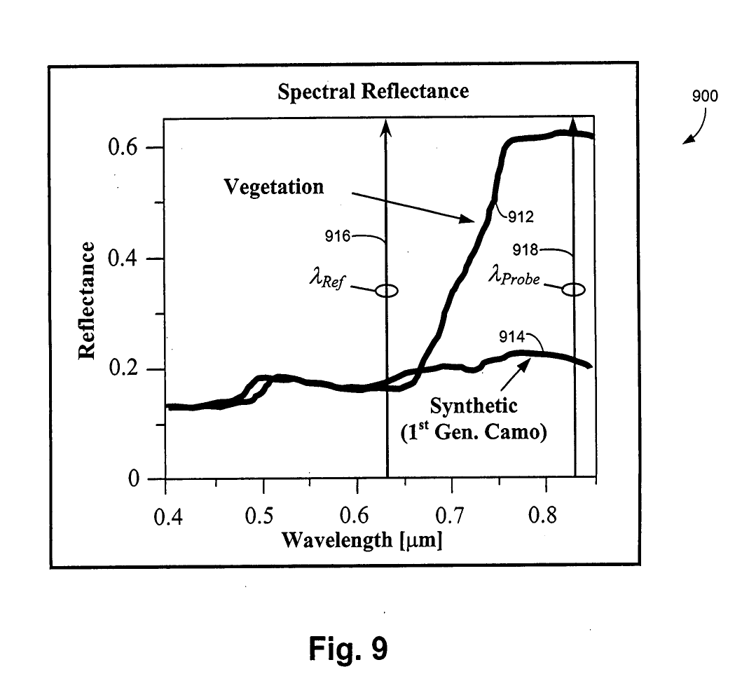

In one experiment, for example, synthetic leaves were distinguished from a high clutter vegetation background. Referring now to FIG. 9, a graph 900 is presented showing the spectral reflectivity curves of the synthetic leaves and the vegetation. As shown in FIG. 9, the reflectivity 912 of the vegetation changes from a relatively low value to a relatively high value at about 700 nm. By contrast, the reflectivity 914 of the synthetic leaves stays fairly constant over the full spectrum. When a laser having a wavelength of 635 nm (represented by line 916) was used as a source, the synthetic leaves were not successfully distinguished from the vegetation. However, when a laser having a wavelength of 830 nm was used (represented by line 918), the synthetic leaves were easily distinguished from the vegetation, and a high detection efficiency was achieved.

From the above discussion, it will be appreciated that many of the problems associated with known optical target identification systems are addressed by the teachings of the present invention. The present invention utilizes an emission of electromagnetic radiation that has been created from two or more differently modulated emissions of electromagnetic radiation to achieve a high detection efficiency. The invention enables optical fields to be detected and processed with the stability and simplicity of modern radio-frequency radar/communications systems. Advantageously, the emission of electromagnetic radiation may be either coherent or incoherent. Moreover, a target identification system in accordance with the invention may utilize a receiver that is configured for direct detection. Therefore, the receiver need not have a large bandwidth.

Of course, the present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1-90. (canceled)

91. A method for acquiring information about at least one target through the use of at least one beam of electromagnetic radiation comprising:
forming a beam of electromagnetic radiation for each target;
for each beam of electromagnetic radiation,
modulating a first portion of the beam with a first modulating device,
modulating a second portion of the beam with a second modulating device, and
combining the first portion and second portion to form a hybrid beam;
radiating each one of the at least one target with an individual one of the hybrid beams to form a first reflected portion and a second reflected portion; and
determining information about each target by processing the first reflected portion and the second reflected portion from the individual one of the hybrid beams radiating that target.

92. The method of claim 91, wherein each hybrid beam is formed with a coherency selected from the group consisting of coherent first and second portions, incoherent first and second portions, and a coherent first portion and incoherent second portion.

93. The method of claim 91, wherein the first and second modulating devices provide modulation selected from the group consisting of frequency modulation, polarization modulation, and phase modulation.

94. The method of claim 91, wherein determining information about each includes processing the first reflected portion and the second reflected portion to generate information selected from the group consisting of image information, velocity information, and range information.

95. The method of claim 91, wherein processing the first reflected portion and the second reflected portion with a receiver having a configuration selected from the group consisting of: direct detection, coherent detection, detection of a signal representing a difference between the first reflected portion and the second reflected portion.

96. The method of claim 91, wherein each one of the at least one beam of electromagnetic radiation has a distinct bandwidth.

97. Apparatus for acquiring information about at least one target through the use of at least one beam of electromagnetic radiation comprising:
a source forming a beam of electromagnetic radiation for each target;
for each beam of electromagnetic radiation,
a first modulating device for modulating a first portion of the beam,
a second modulating device for modulating a second portion of the beam with a second modulating device, and
a guide for combining the first portion and second portion to form a hybrid beam;
an aperture configured for radiating each one of the at least one target with an individual one of the hybrid beams to form a first reflected portion and a second reflected portion; and
a receiver configured to determine information about each target by processing the first reflected portion and the second reflected portion from the individual one of the hybrid beams radiating that target.

98. The apparatus of claim 97, wherein the source is configured to form each hybrid beam with a coherency selected from the group consisting of coherent first and second portions, incoherent first and second portions, and a coherent first portion and incoherent second portion.

99. The apparatus of claim 97, wherein the first and second modulating devices are configured to provide modulation selected from the group consisting of frequency modulation, polarization modulation, and phase modulation.

100. The apparatus of claim 97, wherein the receiver is configured to determine information about each target including information selected from the group consisting of image information, velocity information, and range information.

101. The apparatus of claim 97, wherein the receiver is configured to detect reflected radiation selected from the group consisting of: direct detection, coherent detection, and detection of a signal representing a difference between the first reflected portion and the second reflected portion.

102. The apparatus of claim 97, wherein the source producing each one of the at least one beam of electromagnetic radiation has a distinct bandwidth.
